(19) United States
(12) Patent Application Publication
(10) Pub. No.: US 2025/0203271 A1
(43) Pub. Date: Jun. 19, 2025

(54) A DETACHABLE SENSING EAR TIP FOR AN EAR-WORN DEVICE, THE EAR-WORN DEVICE AND A BASE UNIT

(71) Applicant: HEARABLE LABS UG (HAFTUNGSBESCHRÄNKT), Berlin (DE)

(72) Inventor: Pauline O'CALLAGHAN, Berlin (DE)

(73) Assignee: HEARABLE LABS UG (HAFTUNGSBESCHRÄNKT), Berlin (DE)

(21) Appl. No.: 18/840,079

(22) PCT Filed: May 25, 2024
(86) PCT No.: PCT/EP2022/064337

§ 371 Date: Aug. 21, 2024

(30) Foreign Application Priority Data
May 26, 2021 (EP) 21176084.8
Nov. 26, 2021 (EP) 21210885.6

(51) Int. Cl. H04R 1/10; H04R 25/00; H04R 25/02

(52) U.S. Cl. CPC H04R 1/1091; H04R 1/1016; H04R 1/1066; H04R 25/02; H04R 25/556; H04R 25/656; H04R 2225/57; H04R 2420/09

(57) ABSTRACT

The invention is related to an ear-worn device (1), particularly an earphone or a hearing aid, comprising a base unit (40), and an ear tip (33), wherein the ear tip (33) comprises a sensor (14, 34) configured to detect a biological signal and to issue an electrical sensor signal indicative of the detected biological signal. The base unit (40) and the ear tip (33) are repeatedly and removably connectable via a mechanical connector assembly (70) of the ear-worn device (1), wherein the ear-worn device (1) comprises an electrical connector assembly (180), particularly comprising an electrically conductive mating connection, wherein the electrical connector assembly (180) is configured to conduct the sensor signal from the sensor (14, 34) to the base unit (40).

The invention is related to an ear-worn device. It is further related to the ear tip and the base unit of the ear-worn device. The ear-worn device can be an earphone or a hearing aid.

In the context of the present application, an ear tip is also referred to as ear pad, soft tip, sleeve, sleeve part or sleeve portion. The sleeve part can be referred to as a housing.

In the context of the present application, an earbud is also referred to as base unit. The base unit can comprise a first module. The base unit can comprise a second module.

In particular, the invention is related to an ear tip comprising a sensor configured to detect a signal, particularly a biological signal.

The measurement of biological signals at or inside the ear has been employed for many years in healthcare applications. Signals can be obtained to calculate vital signs such as core body temperature, heart rate and blood oxygen saturation. In recent years, sensors for detecting these signals at or in the ear have been incorporated into wearable devices to facilitate continuous monitoring of health and fitness. For example, many sport ear-worn device manufacturers include photoplethysmography sensors (PPG sensors) positioned in the concha of the ear to detect heart rate signals of the user.

The advantages of detecting biological signals from inside the ear canal, rather than at the outer ear, are known from the prior art. However, obtaining these signals in wearable devices is non-trivial. Ear-worn devices usually incorporate a ‘soft tip’ which is insertable in the ear canal for comfort and noise isolation. This soft tip may have a generic fit shape or a custom fit shape. Either way, the biological signals must be detected through the soft tip, since it is the only part that is in contact with the ear canal.

In the prior art, this has been achieved in two ways:
1) The sensor is included in the main, rigid body of the earbud and a transparent soft tip is employed to allow light signals to pass through it.
2) The sensor is included on a flexible printed circuit board (PCB) that extends into the soft ear-tip and a ‘window’ is cut out in the soft ear tip so that the sensor is in close contact with the skin of the ear canal.

Method 2) has an advantage for quality of signal detection. In addition to light-based sensors being in closer proximity to their measurement target, this arrangement opens up possibilities for contact sensors such as contact thermometers, contact microphones and electroencephalogram (EEG) electrodes.

However, this method also presents an issue for many ear-worn device applications: if a flexible PCB is embedded in the soft-tip and connects back to the main electronics in the earbud, there is no possibility for a user to switch soft-tips. Generally, users of ear-worn devices need to be able to do this so that they can select a soft tip that best fits their ear canal size, and so that they can change or clean soft-tips over time for hygienic reasons or due to wear and tear.

Hence, an ear tip is of interest that provides the detection of a biological signal and that is repeatedly and removably connectable with the earbud, i.e with the base unit of the ear-worn device. Also, a base unit is of interest configured to be repeatedly and removably connectable with the ear tip.

These objectives are attained by the ear-worn device according to claim 1, the ear tip according to claim 9, the base unit according to claim 12 and the method to generate the ear tip according to claim 14. Further embodiments of the invention are specified by the dependent claims and are described hereafter.

A first aspect of the invention relates to an ear-worn device, particularly an earphone or a hearing aid, comprising a base unit, and an ear tip. The ear tip comprises a sensor configured to detect a biological signal and to issue an electrical sensor signal indicative of the detected biological signal. The base unit and the ear tip are repeatedly and removably connectable via a mechanical connector assembly of the ear-worn device, wherein the ear-worn device comprises an electrical connector assembly, particularly comprising an electrically conductive mating connection, wherein the electrical connector assembly is configured to conduct the sensor signal from the sensor to the base unit.

The base unit can comprise a first module and a second module. The base unit can comprise a main body.

The ear tip can comprise or consist of a soft material. The ear tip can comprise or consist of a bio-compatible material.

The ear tip is repeatedly connectable with the base unit. The ear tip can be repeatedly attached and/or detached with the base unit. The ear tip is removably connectable with the base unit. The ear tip can be removed from the base unit and can be connected with the base unit again. For instance, the ear tip can be removed from the base unit for cleaning and can be re-connected with the base unit after cleaning.

The ear-worn device can be an earphone or a hearing aid. The ear-worn device can be a wearable to detect vital signs. The ear-worn device can be an ear-worn device configured for hearing protection. The ear-worn device can be an industrial ear worn device, particularly an ear-worn device for hearing protection and/or communication. The ear-worn device can be an ear-worn device intended for sleeping, in particular an ear plug or a sleepbud with noise masking electronics.

The electrical connector assembly can be configured to relay the sensor signal from the sensor towards the base unit. The base unit can be configured to receive, process, store and/or send the sensor signal.

The electrical connector assembly can be configured to conduct a signal from the base unit towards to the ear tip. In an embodiment, the electrical connector assembly is configured to conduct a signal from the base unit towards to the ear tip and to conduct the sensor signal from the sensor to the base unit.

The ear-worn device can comprise a plurality of sensors. The ear-worn device can comprise a plurality of sensors, wherein each sensor is arranged and configured to detect a particular biological signal. The ear-worn device can be configured to detect a plurality of biological signals.

The ear-worn device, particularly the electrical connector assembly, can comprise a plurality of electrically conductive mating connections.

In an embodiment, the device comprises two parts: an electronic circuit including biological sensors, conductors and a connector embedded in a soft, bio-compatible material; and an electronic circuit including a mating connecter contained inside the main body of the ear worn device.

In an embodiment, the sensor is arranged to detect a biological signal from the skin inside the ear canal of the user.

The base unit can comprise a main electronic unit. The base unit of the ear-worn device, can comprise a connector configured to mate with the sleeve connector and thus provide an electrical connection between the electronics embedded in the sleeve and the main electronic unit in the ear-worn device arranged in the base unit.

The advantage of the ear-worn device is that the tip is removable from and/or re-connectable with the base unit, particularly without destruction of the ear tip and/or the base unit. Advantageously, a new ear tip can be connected with the base unit in case the user changes. The user can select a particular ear tip and connect it with the base unit. Advantageously, a single base unit can be used for a longer duration. This can decrease the costs. The soft tip, is advantageously detachable and replaceable by the user to facilitate changing sleeve sizes or cleaning/replacing a tip for hygiene reasons.

In an embodiment, the electrical connector assembly comprises a first electrical connector element of the electrical connector assembly arranged at the ear tip and a second electrical connector element of the electrical connector assembly arranged at the base unit, wherein the first electrical connector element of the electrical connector assembly is operatively coupled to a sensor assembly comprising the sensor, wherein the first electrical connector element of the electrical connector assembly is configured and arranged to contact the second electrical connector element of the electrical connector assembly that is formed complementary to the first electrical connector element.

The first electrical connector element of the electrical connector assembly can be coupled electrically conductively to the sensor assembly.

The electrical connector assembly can be arranged and configured to be repeatedly and removably assemblable. The electrical connector assembly can be arranged and configured such that it can be repeatedly and removably assembled. The first electrical connector element of the electrical connector assembly can be arranged and configured to be repeatedly and removably assemblable with the second electrical connector element of the electrical connector assembly. The first electrical connector element of the electrical connector assembly can be arranged and configured such that it can be repeatedly and removably assembled with the second electrical connector element of the electrical connector assembly. The assembled state can be reversible. The assembled state can be repeatably reversible.

Advantageously, the electrical connection can be disconnected and/or reconnected when the ear tip is replaced.

The sensor assembly can comprise the sensor. The sensor assembly can comprise a plurality of sensors.

In an embodiment, the mechanical connector assembly comprises a first mechanical connector element of the mechanical connector assembly arranged at the ear tip and a corresponding second mechanical connector element of the mechanical connector assembly arranged at the base unit, wherein the mechanical connector assembly is arranged and configured such that in an assembled state, the ear tip and the base unit are friction locked and/or positively coupled, such that an electrical connection via the electrical connector assembly is established.

In an embodiment, the mechanical connector assembly comprises or consists of:
a clip and a corresponding recess,
a groove and a corresponding protrusion, and/or
a magnet and a magnetic counterpart.

The first mechanical connector element can be one of a clip, a recess, a groove, a protrusion, a magnet, or a magnetic counterpart. The second mechanical connector element can be one of a clip, a recess, a groove, a protrusion, a magnet, or a magnetic counterpart.

In an embodiment, the first mechanical connector element of the mechanical connector assembly is the clip and the second mechanical connector element of the mechanical connector assembly is the corresponding recess.

In an embodiment, the second mechanical connector element of the mechanical connector assembly is the clip and the first mechanical connector element of the mechanical connector assembly is the corresponding recess.

In an embodiment, the first mechanical connector element of the mechanical connector assembly is the groove and the second mechanical connector element of the mechanical connector assembly is the corresponding protrusion.

In an embodiment, the second mechanical connector element of the mechanical connector assembly is the groove and the first mechanical connector element of the mechanical connector assembly is the corresponding protrusion.

In an embodiment, the first mechanical connector element of the mechanical connector assembly is the magnet and the second mechanical connector element of the mechanical connector assembly is the magnetic counterpart.

In an embodiment, the second mechanical connector element of the mechanical connector assembly is the magnet and the first mechanical connector element of the mechanical connector assembly is the magnetic counterpart.

The assembled state can be an assembled position.

The mechanical connector assembly can be arranged and configured to be repeatedly and removably assemblable. The mechanical connector assembly can be arranged and configured such that it can be repeatedly and removably assembled. The first mechanical connector element of the mechanical connector assembly can be arranged and configured to be repeatedly and removably assemblable with the second mechanical connector element of the mechanical connector assembly. The first mechanical connector element of the mechanical connector assembly can be arranged and configured such that is can be repeatedly and removably assembled with the second mechanical connector element of the mechanical connector assembly. The first mechanical connector element of the mechanical connector assembly can be arranged and configured such that is can be repeatedly attached and/or detached with the second mechanical connector element of the mechanical connector assembly.

Advantageously, the mechanical connection can be disconnected and/or reconnected when the ear tip is replaced. The assembled state can be reversible. The assembled state can be repeatably reversible.

The first and second mechanical connector element can be configured to establish a physical connection between the first and second mechanical connector element, particularly between the ear tip and the base unit. The mechanical connector element may comprise or consist of a magnet or a magnetic element.

According to an embodiment, the base unit comprises a protruding core portion and the ear tip comprises a central part that comprises a hollow channel portion formed complementary to the protruding core portion, wherein the core portion and the channel portion are configured such that the core portion is at least partially insertable in the channel portion, wherein at a distal end of the protruding core portion the core portion comprises an engaging element, that is configured to engage with a proximal end of the channel portion, when the core portion is inserted in the central part, particularly in the channel portion, such that at least a positive lock between the base unit and the ear tip is established.

The protruding core portion can protrude along a longitudinal protrusion direction. The engaging element can radially protrude with respect to the longitudinal protrusion direction. The engaging element can form a flange, particularly a circumferential flange.

The ear tip can at least partially surround the core portion, when the core portion is inserted in the central part particularly in the channel portion.

According to an embodiment, the ear tip is formed in a mushroom shape, wherein the ear tip comprises:
a central part, wherein the central part comprises a channel portion, particularly a hollow channel portion, extending along a longitudinal extension direction, wherein the channel portion comprises a distal end and a proximal end, wherein at the distal end, the channel portion delimits a distal opening,
an outer part emerging radially with respect to the longitudinal extension direction of the channel portion from or connected to the distal end of the channel portion, extending towards the proximal end of the channel portion, wherein the outer part comprises a surface, wherein the surface is configured to be in contact with an internal surface of an ear canal when the ear tip is inserted into the ear canal of a user,
a sensor assembly comprising the sensor, particularly a skin-contact sensor, wherein the sensor is arranged at the outer part, particularly at the surface of the outer part, and
the first electrical connector element of the electrical connector assembly operatively coupled to the sensor assembly.

The distal end of the channel portion can be at the tip of the ear tip.

The mushroom shape can be an umbrella shape. The ear tip can have a convex shape. Particularly, the outer part can have a convex shape. In an embodiment, the outer part, particularly the surface of the outer part has a dome-shape. The outer part can be centred around the distal opening of the channel portion.

The first electrical connector element of the electrical connector assembly can be operatively coupled to the sensor assembly, wherein the first electrical connector element of the electrical connector assembly can be arranged at the proximal end of the channel portion. The first electrical connector element can be configured and arranged to contact a second electrical connector element of the electrical connector assembly arranged at a base unit. The second electrical connector element can be shaped complementary to the first electrical connector element. The first electrical connector element and the second electrical connector element can be configured to form an electrical connector assembly generating an electrically conductive connection.

The shape of the second electrical connector element can be complementary to the shape of the first electrical connector element of the electrical connector assembly.

The sensor can be arranged at the surface of the outer part. The sensor can be covered by a protective layer. The protective layer can be arranged and configured to protect the sensor from moisture. The protective layer can be a thin silicone layer. In particular, the protective layer is a thin, transparent silicone layer.

In an embodiment, the sensor and/or the sensor assembly is operatively coupled to the first electrical connector element of the electrical connector assembly by a flexible electrical connection, particularly wherein the flexible electrical connection comprises or consists of a flexible conductor and/or a flexible printed circuit board embedded in the ear tip and/or wherein the ear tip or a section of the ear tip consists of a conductive material.

The flexible electrical connection can comprise a plurality of flexible conductors.

The flexible conductor can extend along a conductor extension direction. The conductor extension direction can be curved. In an embodiment, the conductor extension direction extends from an outer edge of the outer part towards the channel portion that delimits the distal opening of the channel portion, towards the proximal end of the channel portion.

The flexible conductor can comprise a curved section. In an embodiment, the flexible conductor comprises a plurality of curved sections. The curved section of the flexible conductor can be curved perpendicular to the conductor extension direction.

The conductive material can comprise a conductive polymer. In an embodiment, this conductive material forms an electrical connection with a conductive element in the base unit to carry signals between them.

In an embodiment, the material or part of the material forming the ear tip has electrochemical properties that make it suitable for sensing bioelectrical signals from the skin of the user.

In an embodiment, the ear tip comprises a first mechanical alignment element that is particularly comprised in the first mechanical connector element and the base unit comprises a corresponding second mechanical alignment element, particularly comprised in the second mechanical connector element, wherein the two alignment elements are configured and shaped such that the base unit and the ear tip may only be assembled with an orientation to each other that is defined by the shape of the two elements such that the first electrical connector element and the second electrical connector element are directly facing each other and/or such that the base unit and the ear tip are aligned with each other such that the base unit and the ear tip are mechanically connectable via the mechanical connector assembly.

The first mechanical connector element can comprise the first mechanical alignment element. The second mechanical connector element can comprise the second mechanical alignment element.

According to an embodiment, the first mechanical alignment element is separate from the first mechanical connector element. According to an embodiment, the second mechanical alignment element is separate from the second mechanical connector element.

The first mechanical alignment element can be arranged and configured to be repeatedly and removably alignable with the second mechanical alignment element. The first mechanical alignment element can be arranged and configured such that it can be repeatedly and removably aligned with the second mechanical alignment element. The alignment can be reversible. The alignment can be repeatably reversible.

According to an embodiment, the electrical connector assembly comprises a spring-loaded electrical contact pin and a metal pad, particularly wherein the first electrical connector element is the metal pad and the second electrical connector element is the spring-loaded electrical contact pin.

In an embodiment, the electrical connector assembly comprises a plurality of spring-loaded electrical contact pins and a plurality of metal pads. In an embodiment, the plurality of spring-loaded electrical contact pins equals the plurality of metal pads. In an embodiment, the plurality of spring-loaded electrical contact pins and the plurality of metal pads are configured and arranged such that each spring-loaded electrical contact pin of the plurality of spring-loaded electrical contact pins can mate with a corresponding metal pad of the plurality of metal pads.

In an embodiment, the electrical connector assembly comprises a pogo pin. In particular, the pogo pin is arranged at the base unit.

The electrical connector assembly can comprise a metal pad complementary to the pogo pin. In particular, the metal pad is arranged at the ear tip.

In an embodiment, the base unit comprises a PCB. In an embodiment, the base unit comprises a PCB comprising a first section and a second section, wherein the first section is a flexible PCB and the second section is a rigid PCB. In an embodiment, the spring-loaded electrical contact pin, particularly the pogo pin is arranged at the rigid part of a rigid-flexible PCB. The flexible part of the PCB can carry the sensor signal between the rigid part and the main electronics of the ear-worn device.

In an embodiment, the spring-loaded electrical contact pin, particularly the pogo pin is connected back to the main electronics via a wire, e.g. via a litz wire.

The ear-worn device can be arranged and configured such that in the assembled state, the spring-loaded electrical contact pin and the corresponding metal pad are pressed together.

In an embodiment, the sleeve comprises metal pads configured to mate with the pogo pins when the base unit and the sleeve are pressed together. The metal pads are electrically connected to the electronic circuit inside the ear tip.

In an embodiment, the pogo pins on the base unit and the pads on the ear tip are compressed together to form a reliable electrical contact by means of a mechanical feature. The mechanical feature can be the mechanical connector assembly. The mechanical feature can comprise the first mechanical connector element. The mechanical feature can comprise the second mechanical connector element. The mechanical feature can comprise the first mechanical alignment element. The mechanical feature can comprise the second mechanical alignment element.

The plurality of pogo pin connectors can be arranged such that they can align with corresponding pads on the ear tip. In particular, each pogo pin connector of the plurality of pogo pin connectors can align with a corresponding metal pad on the sleeve part.

In an embodiment, the base unit and the sleeve part lock together via grooves. The core part and the ear tip can be configured such that the pogo pin connectors and pads are aligned via an alignment key on both parts (base unit and the sleeve part). The alignment key can comprise a groove and a corresponding protrusion that can be insertable in the groove. In an embodiment, the core part comprises the groove. The ear tip can comprise the protrusion.

In an embodiment, the ear-worn device comprises a clip, in particular a plurality of clips, wherein the clip is arranged and configured to lock the base unit and the ear tip together. In an embodiment, the clip is arranged and configured to lock the base unit and the sleeve part together and to align the pogo pin connectors and the corresponding metal pads.

In an embodiment, the electrical connector assembly comprises a male pin and a corresponding female receptable configured to receive the male pin to generate the electrical connection, wherein the male pin and/or the female receptable are configured such that they press together in the assembled state.

In an embodiment, the electrical connector assembly comprises a plurality of male pins and a plurality of female receptables. In an embodiment, the plurality of male pins equals the plurality of female receptables. In an embodiment, the plurality of male pins and the plurality of female receptables are configured and arranged such that each male pin of the plurality of male pins can mate with a corresponding female receptable of the plurality of female receptables.

In an embodiment, the male pins and/or the female receptacles include a feature that causes them to be pressed together with force on mating.

In an embodiment, the base unit comprises a loudspeaker and/or a microphone.

The microphone can be an ambient microphone. The microphone can be an in-ear-microphone.

In an embodiment, the base unit comprises a loudspeaker, wherein the loudspeaker is arranged such that it faces towards the core portion, particularly a distal end of the protruding core portion, wherein when the ear tip is connected to the base unit, the loudspeaker can emit a sound through the channel portion of the ear tip, particularly such that the loudspeaker can emit a sound through the distal opening of the ear tip.

According to an embodiment, the base unit comprises a processing unit configured to receive, process, store and/or send a sensor signal obtained by the sensor, particularly the sensor assembly, and/or processed data.

According to an embodiment, the base unit comprises a processing unit configured to receive, process, store and/or send data obtained by the sensor, particularly the sensor assembly, and/or processed data.

In an embodiment, the ear-worn device comprises the microphone and the loudspeaker, wherein the microphone is arranged distal to the loudspeaker, such that when the ear worn device is arranged in the ear canal of a user the microphone, the loudspeaker and the ear canal form an acoustic chamber, wherein the loudspeaker is arranged and configured to output an audio signal into the acoustic chamber and the microphone is arranged and configured to detect a resulting audio signal carrying information on an audio signal present in the ear.

In an embodiment, the microphone is arranged and configured to detect a resulting audio signal carrying information on how the audio signal is behaving inside the ear canal.

In an embodiment, the resulting audio signal carries information on all audio signals present in the ear. In addition to the audio resulting from the loudspeaker output, this may include the user's own voice, chewing, heartbeat.

In an embodiment, the resulting audio signal provides a closed loop in the audio path which is advantageous for applying signal processing algorithms.

In an embodiment, the biological signal detectable by the sensor and/or the sensor assembly is a heart rate, a blood oxygen saturation, a body temperature, a respiration rate, blood glucose level, a hormone level, an electroencephalogram signal of the user, or a sound signal detected from inside the body of the user.

The biological signals can be ECG, blood pressure, heart rate variability, galvanic skin response.

In an embodiment, the sensor is a thermometer, wherein the thermometer is an infra-red thermometer, wherein the infra-red thermometer is arranged in the protruding core part, wherein the infra-red thermometer is arranged and configured to detect an ear drum of the user when the ear-worn device is arranged in the ear channel of the user to detect a core body temperature of the user and/or wherein the thermometer is a contact thermometer.

In an embodiment, the infra-red thermometer is arranged in the base unit.

In an embodiment, the ear-worn device comprises a lighting element, wherein the ear-worn device is configured such that When the sleeve has been correctly connected to the base unit, a light, particularly a sequence of lights, flash on the sleeve as visual confirmation of connection to the user.

A second aspect of the invention is related to an ear tip, particularly the ear tip according to the invention, wherein the ear tip is formed in a mushroom shape, wherein the ear tip comprises:
a central part, wherein the central part comprises a channel portion, particularly a hollow channel portion, extending along a longitudinal extension direction, wherein the channel portion comprises a distal end and a proximal end, wherein at the distal end, the channel portion limits a distal opening,
an outer part emerging radially with respect to the longitudinal extension direction of the channel portion from or connected to the distal end of the channel portion, extending towards the proximal end of the channel portion, wherein the outer part comprises a surface, wherein the surface is configured to be in contact with an internal surface of an ear canal when the ear tip is inserted into the ear canal of a user,
a sensor assembly comprising the sensor, particularly a skin-contact sensor, wherein the sensor is arranged at the outer part, particularly at the surface of the outer part, and
a first electrical connector element of the electrical connector assembly operatively coupled to the sensor assembly, wherein the first electrical connector element of the electrical connector assembly is arranged at the proximal end of the channel portion, wherein the first electrical connector element is configured and arranged to contact a second electrical connector element of the electrical connector assembly arranged at a base unit, wherein the second electrical connector element is shaped complementary to the first electrical connector element, wherein the first electrical connector element and the second electrical connector element are configured to form an electrical connector assembly generating an electrically conductive connection.

In an embodiment, ear tip comprises a first mechanical connector element of a mechanical connector assembly, wherein the first mechanical connector element as arranged and configured to contact a second mechanical connector element of the mechanical connector assembly arranged at the base unit, wherein the first mechanical connector element and the second mechanical connector element are configured to form the mechanical connector assembly, wherein the mechanical connector assembly is arranged and configured such that in an assembled state, the ear tip and the base unit are friction locked and/or positively coupled, such that an electrical connection via the electrical connector assembly is established.

According to an embodiment, the ear tip comprises a first mechanical alignment element that is particularly comprised in the first mechanical connector element, wherein the first mechanical alignment element is arranged and configured to align with a second mechanical alignment element arranged at the base unit, wherein the two alignment elements are configured and shaped such that the base unit and the ear tip may only be assembled with a orientation to each other that is defined by the shape of the two elements such that the first electrical connector element and the second electrical connector element are directly facing each other and/or such that the base unit and the ear tip are aligned with each other such that they are mechanically connectable via the mechanical connector assembly.

The mushroom shape can be an umbrella shape. The ear tip can have a convex shape. Particularly, the outer part can have a convex shape. In an embodiment, the outer part, particularly the surface of the outer part has a dome-shape. The outer part can be centred around the distal opening of the channel portion.

The first electrical connector element of the electrical connector assembly can be operatively coupled to the sensor assembly, wherein the first electrical connector element of the electrical connector assembly can be arranged at the proximal end of the channel portion. The first electrical connector element can be configured and arranged to contact a second electrical connector element of the electrical connector assembly arranged at a base unit. The second electrical connector element can be shaped complementary to the first electrical connector element. The first electrical connector element and the second electrical connector element can be configured to form an electrical connector assembly generating an electrically conductive connection.

The shape of the second electrical connector element can be complementary to the shape of the first electrical connector element of the electrical connector assembly.

In an embodiment, the sensor and/or the sensor assembly is operatively coupled to the first electrical connector element of the electrical connector assembly by a flexible electrical connection, particularly wherein the flexible electrical connection comprises or consists of a flexible conductor and/or a flexible printed circuit board embedded in the ear tip and/or wherein the ear tip or a section of the ear tip consists of a conductive material.

The flexible electrical connection can comprise a plurality of flexible conductors.

The flexible conductor can extend along a conductor extension direction. The conductor extension direction can be curved. In an embodiment, the conductor extension direction extends from an outer edge of the outer part towards the channel portion that delimits the distal opening of the channel portion, towards the proximal end of the channel portion.

The flexible conductor can comprise a curved section. In an embodiment, the flexible conductor comprises a plurality of curved sections. The curved section of the flexible conductor can be curved perpendicular to the conductor extension direction.

The conductive material can comprise a conductive polymer. In an embodiment, this conductive material forms an electrical connection with a conductive element in the base unit to carry signals between them.

In an embodiment, the material or part of the material forming the ear tip has electrochemical properties that make it suitable for sensing bioelectrical signals from the skin of the user.

In an embodiment, the ear tip comprises a first mechanical alignment element that is particularly comprised in the first mechanical connector element and the base unit comprises a corresponding second mechanical alignment element, particularly comprised in the second mechanical connector element, wherein the two alignment elements are configured and shaped such that the base unit and the ear tip may only be assembled with a orientation to each other that is defined by the shape of the two elements such that the first electrical connector element and the second electrical connector element are directly facing each other and/or such that the base unit and the ear tip are aligned with each other such that the base unit and the ear tip are mechanically connectable via the mechanical connector assembly.

The first mechanical connector element can comprise the first mechanical alignment element. The second mechanical connector element can comprise the second mechanical alignment element.

According to an embodiment, the first mechanical alignment element is separate from the first mechanical connector element. According to an embodiment, the second mechanical alignment element is separate from the second mechanical connector element.

The first mechanical alignment element can be arranged and configured to be repeatedly and removably alignable with the second mechanical alignment element. The first mechanical alignment element can be arranged and configured such that it can be repeatedly and removably aligned with the second mechanical alignment element. The alignment can be reversible. The alignment can be repeatably reversible.

A third aspect of the invention is related to a base unit, particularly the base unit according to the invention, wherein the base unit comprises a second electrical connector element of the electrical connector assembly, wherein the second electrical connector element is configured and arranged to contact a first electrical connector element of the electrical connector assembly arranged at a ear tip, wherein the second electrical connector element is shaped complementary to the first electrical connector element, wherein the first electrical connector element and the second electrical connector element are configured to form an electrical connector assembly generating an electrically conductive connection.

In an embodiment, the base unit comprises a second mechanical connector element of a mechanical connector assembly, wherein the second mechanical connector element as arranged and configured to contact a first mechanical connector element of the mechanical connector assembly arranged at the ear tip, wherein the first mechanical connector element and the second mechanical connector element are configured to form the mechanical connector assembly, wherein the mechanical connector assembly is arranged and configured such that in an assembled state, the ear tip and the base unit are friction locked and/or positively coupled, such that an electrical connection via the electrical connector assembly is established.

In an embodiment, the base unit comprises a second mechanical alignment element that is particularly comprised in the second mechanical connector element, wherein the second mechanical alignment element is arranged and configured to align with a first mechanical alignment element arranged at the ear tip, wherein the two alignment elements are configured and shaped such that the base unit and the ear tip may only be assembled with a orientation to each other that is defined by the shape of the two elements such that the first electrical connector element and the second electrical connector element are directly facing each other and/or such that the base unit and the ear tip are aligned with each other such that they are mechanically connectable via the mechanical connector assembly.

The first electrical connector element of the electrical connector assembly can be operatively coupled to the sensor assembly, wherein the first electrical connector element of the electrical connector assembly can be arranged at the proximal end of the channel portion. The first electrical connector element can be configured and arranged to contact a second electrical connector element of the electrical connector assembly arranged at a base unit. The second electrical connector element can be shaped complementary to the first electrical connector element. The first electrical connector element and the second electrical connector element can be configured to form an electrical connector assembly generating an electrically conductive connection.

The shape of the second electrical connector element can be complementary to the shape of the first electrical connector element of the electrical connector assembly.

In an embodiment, the sensor and/or the sensor assembly is operatively coupled to the first electrical connector element of the electrical connector assembly by a flexible electrical connection, particularly wherein the flexible electrical connection comprises or consists of a flexible conductor and/or a flexible printed circuit board embedded in the ear tip and/or wherein the ear tip or a section of the ear tip consists of a conductive material.

The flexible electrical connection can comprise a plurality of flexible conductors.

The flexible conductor can extend along a conductor extension direction. The conductor extension direction can be curved. In an embodiment, the conductor extension direction extends from an outer edge of the outer part towards the channel portion that delimits the distal opening of the channel portion, towards the proximal end of the channel portion.

The flexible conductor can comprise a curved section. In an embodiment, the flexible conductor comprises a plurality of curved sections. The curved section of the flexible conductor can be curved perpendicular to the conductor extension direction.

The conductive material can comprise a conductive polymer. In an embodiment, this conductive material forms an electrical connection with a conductive element in the base unit to carry signals between them.

In an embodiment, the material or part of the material forming the ear tip has electrochemical properties that make it suitable for sensing bioelectrical signals from the skin of the user.

In an embodiment, the ear tip comprises a first mechanical alignment element that is particularly comprised in the first mechanical connector element and the base unit comprises a corresponding second mechanical alignment element, particularly comprised in the second mechanical connector element, wherein the two alignment elements are configured and shaped such that the base unit and the ear tip may only be assembled with a orientation to each other that is defined by the shape of the two elements such that the first electrical connector element and the second electrical connector element are directly facing each other and/or such that the base unit and the ear tip are aligned with each other such that the base unit and the ear tip are mechanically connectable via the mechanical connector assembly.

The first mechanical connector element can comprise the first mechanical alignment element. The second mechanical connector element can comprise the second mechanical alignment element.

According to an embodiment, the first mechanical alignment element is separate from the first mechanical connector element. According to an embodiment, the second mechanical alignment element is separate from the second mechanical connector element.

The first mechanical alignment element can be arranged and configured to be repeatedly and removably alignable with the second mechanical alignment element. The first mechanical alignment element can be arranged and configured such that it can be repeatedly and removably aligned with the second mechanical alignment element. The alignment can be reversible. The alignment can be repeatably reversible.

The base unit can comprise a processing unit. According to an embodiment, the processing unit is configured to receive, process, store and/or send a sensor signal obtained by the sensor, particularly the sensor assembly, and/or processed data.

A further aspect of the invention is related to a method to generate an ear tip, particularly the ear tip according to the invention, comprising the steps of:
generating a pre-state of the ear tip, particularly by moulding or 3D printing,
transferring a flexible electrical connection to the pre-state of the ear tip, wherein transferring comprises a 2D inkjet printing process, a 3D printing process and/or a pressure and irradiation process,
assembling of a sensor, particularly a sensor assembly onto the flexible electrical connection,
coating the flexible electrical connection and/or the sensor, particularly the sensor assembly by a protective layer,
forming the ear tip from the pre-state of the ear tip, particularly by thermoforming.

A further item of the invention relates to an ear worn device, particularly a wireless headphone or a hearing aid, comprising a first module (herein also referred to as “transducer bundle”) configured to be inserted at least partially into an ear canal of a user. The first module comprises a loudspeaker configured to emit sound into the ear canal of the user, particularly when the first module is inserted into the ear canal. The first module further comprises at least one microphone, particularly comprising a first ambient microphone, configured to pick up sound.

The ear worn device further comprises a second module (herein also referred to as “main electronics bundle”), wherein the second module is configured to be arranged outside of the concha cava adjacent to the ear canal of the user when the first module is inserted into the ear canal. The second module comprises at least one electronic component which is operatively coupled to the loudspeaker and/or the at least one microphone of the first module.

The ear worn device, particularly the first module, more particularly the at least one microphone, comprises a first ambient microphone, wherein the first ambient microphone is configured to be arranged behind the tragus of the ear of the user adjacent to the ear canal when the first module is inserted at least partially into the ear canal, such that the concha cava of the ear of the user remains unobstructed. The first ambient microphone faces away from the ear canal of the user when the first module is inserted at least partially into the ear canal.

Environmental sounds may be picked up by the first ambient microphone very close to the natural location where sound filtered by the outer ear enters the ear canal. In this manner, the environmental sounds can be picked up in a sound quality which is very similar to natural perception without earphones or hearing aids. In addition, the first ambient microphone may be used to pick up the user's own voice, e.g. for voice calls or for talking to an automatic voice assistant.

The invention differs from current ear worn devices in that the electronics are split into two parts, a first module and a second module.

The main transducers (e.g., loudspeakers, microphones and some sensors, such as optical sensors configured to measure the heart rate or the blood oxygen saturation of the wearer) are housed inside the ear canal and, in particular, the rest of the electronics are housed outside of the ear.

This enables a novel feature that may be referred to as ‘natural transparency’ in case of wireless headphones. Because this configuration allows the ambient microphone to be placed at the entrance to the ear canal (behind the tragus), and the concha cava to remain unobstructed, sounds picked up from the environment benefit from the natural filtering of the ear's anatomy. This natural filtering, when paired with relevant signal processing algorithms, allows the user to maintain spatial awareness when wearing the ear worn device (both in case of wireless headphones and hearing aids).

The system (ear worn device) according to the invention comprises two main parts: The transducer bundle or first module sits at least partly inside the wearer's ear canal. In particular, it should be small enough to fit into the majority of adult ear canals so that the outermost part sits behind the tragus. The main electronics bundle or second module sits outside of the user's ear (e.g. in front of the ear or behind the ear), particularly housed in an ergonomically designed enclosure, e.g. an injection moulded plastic case with some silicone coverings. The main electronics bundle is electrically connected to the transducer bundle (e.g. by means of a flexible PCB or wire harness).

In certain embodiments, the ear worn device of the invention is configured to pick up sounds from the environment with microphones. In certain embodiments, the ear worn device is configured to perform signal processing on these sounds. In certain embodiments, the ear worn device is configured to play the processed sounds back to a speaker inside the wearer's ear canal, all with an imperceptible delay so that the wearer hears the sounds in real time.

In certain embodiments, the ear worn device may form part of a pair of devices in the category of True Wireless Headphones. In certain embodiments, the ear worn device is a configuration for a hearing aid device.

In certain embodiments, the ear worn device comprises an earpiece configured to be inserted at least partially into the ear canal, wherein the earpiece comprises the first module and wherein the ear worn device comprises a main body connected to the earpiece, wherein the main body comprises the second module, and wherein particularly the main body comprises a first section connected to the earpiece, wherein the ear worn device is configured such that the first section extends upward from the ear canal behind the tragus towards the helicis crus of the ear when the earpiece is inserted into the ear canal, such that the concha cava of the ear remains unobstructed.

Alternatively, in particular, the main body of the ear worn device may be configured to be arranged behind the ear, particularly behind the auricle of the ear, when the user is wearing the ear worn device.

The described shape of the main body results in the concha cava being unobstructed while wearing the ear worn device, such that the natural filtering abilities of the ear, particularly by the pinna of the ear, may be advantageously used to naturally play back environmental sounds, and to improve spatial awareness of the wearer.

In certain embodiments, the main body further comprises a second section connected to the first section, wherein the ear worn device is configured such that the second section extends from the helicis crus along an outside of the helix of the ear of the user when the earpiece is inserted at least partially into the ear canal of the ear. In particular, the second section follows the contour of the helix of the ear, wherein more particularly the second section is curved or the second section comprises at least two straight subsections arranged at an angle between 0° and 45° with respect to each other.

This shape of the main body advantageously leaves most parts of the outer ear unobstructed, further improving the natural filtering ability of the ear to be used to play back natural environmental sounds into the ear canal by the loudspeaker.

In certain embodiments, the main body further comprises a third section connected to the second section, wherein the third section forms a hook configured to be arranged behind the auricle of the ear when the earpiece is inserted at least partially into the ear canal of the ear. The third section firmly and securely attaches the ear worn device at the ear.

In certain embodiments, the earpiece comprises a core part and a sleeve part, wherein the sleeve part is mechanically connectable to the core part, such that the sleeve part is arranged around the core part. The sleeve part is configured to be in contact with the internal surface of the ear canal when the earpiece is inserted into the ear canal. In particular, the sleeve part comprises a flexible material (e.g., silicone) which is adaptable to the shape of the ear canal when the earpiece is inserted into the ear canal. In particular, the core part comprises a housing from a material which is more rigid than the flexible material of the sleeve part.

In certain embodiments, the sleeve part comprises a skin contact sensor, particularly a biometric particularly a photoplethysmographic (PPG) sensor, an electroencephalogram (EEG) electrode or a contact microphone. The skin contact sensor is arranged at the surface of the sleeve part, such that the skin contact sensor is in contact with the skin on the inner surface of the ear canal when the earpiece is inserted in the ear canal. In particular, the skin contact sensor may be formed by a flexible electronic component.

In certain embodiments, the skin contact sensor, particularly the biometric sensor on the sleeve part is a contact thermometer. The contact thermometer can be embedded in the sleeve. An advantage is that embedded in the sleeve, the contact thermometer can be in contact with the skin in a location that has core body temperature (when the earpiece is inserted into the ear canal). An advantage of the contact thermometer embedded in the sleeve is that it can be easily integrated in the device. The costs are reduced advantageously by remaining the efficiency of the thermometer.

In certain embodiments, the contact microphone comprises a microsensor comprising a first sensing electrode connected to a proof mass and a second sensing electrode spaced apart from the proof mass, particularly by a gap of 1-999 nm. In certain embodiments, the contact microphone further comprises a means to convert a voltage between the first and second sensing electrodes into an electrical signal. In this manner, faint sounds from inside the human body can be detected.

In headphones with PPG sensors according to the prior art, the PPG sensor is particularly arranged in the concha cava when the user is wearing the headphones. The above-described embodiment ensures that the concha cava is unobstructed to make use of the natural filtering abilities of the ear.

In certain embodiments, the sleeve part comprises at least one connection contact for electric connection to a corresponding connection contact of the core part.

In certain embodiments, the core part comprises the loudspeaker and the at least one microphone, particularly the first ambient microphone. In certain embodiments, the core part comprises a temperature sensor. In certain embodiments, the core part comprises at least one electrical connection for connection to the second module, particularly in the main body.

In certain embodiments, the sleeve part and the core part are connectable by a plug-in connection, particularly configured such that the connection contacts of the sleeve part and the core part are aligned to be electrically connected. The plug-in connection enables the user to easily switch the sleeve part to obtain an optimal fit to the ear canal.

In certain embodiments, the sleeve part is custom-fit to the user's ear canal. In this case, the outer shape of the sleeve part fits the exact shape of the user's ear canal.

In certain embodiments, the at least one microphone of the first module comprises an in-ear microphone configured to pick up sound from inside the ear canal of the user. In particular, the in-ear microphone faces into the ear canal of the user when the first module is at least partially inserted into the ear canal.

By means of the in-ear microphone, audio signals of sounds from inside the wearer's body, e.g., the wearer's own voice or chewing noises, can be picked up and taken into account during sound processing to recreate natural hearing by the ear worn device. In addition, at least some of the audio signals picked up by the in-ear microphone can be used as biometric data.

In certain embodiments, the first module comprises at least one biometric sensor configured to pick up a biometric signal. In particular, the at least one electronic component of the second module is operatively coupled to the biometric sensor. In particular, the biometric signal is a heart rate, a blood oxygen saturation, a body temperature, a respiration rate, a blood glucose level, a hormone level of the user, or a sound signal picked up from inside the body of the user, wherein more particularly the biometric sensor is a photoplethysmographic (PPG) sensor.

In certain embodiments, the at least one biometric sensor comprises an infrared sensor configured to be facing into the ear canal of the user when the user is wearing the ear worn device, wherein particularly the infrared sensor is configured to measure a body temperature of the user.

In certain embodiments, the ear worn device comprises a first electrode and a second electrode configured to detect a galvanic skin response, an electroencephalogram or an electrocardiogram, wherein particularly the first electrode is comprised in the first module and the second electrode is comprised in the second module.

In certain embodiments, the first electrode and the second electrode are spaced apart from each other, particularly wherein the first electrode is comprised in the first module and the second electrode is comprised in the second module, wherein the first electrode and the second electrode are configured to detect an electroencephalogram or an electro electroencephalogram signal.

In certain embodiments, the ear worn device comprises at least one further electrode (in addition to the first electrode and the second electrode) to detect the galvanic skin, response, the electroencephalogram or the electrocardiogram. In particular, the at least one further electrode is spaced apart from the first electrode and/or from the second electrode.

Such sensors advantageously extend the functionality of the ear worn device beyond that of standard headphones and hearing aids. The picked up biometric data can be transmitted, e.g. to a smart phone or tablet computer of the wearer and further analyzed or viewed. In addition, the biometric signals could also be used to detect a medical condition of the wearer, such as a beginning heart attack or stroke. In this case, an alarm could be automatically triggered and medical personnel could be automatically notified to initiate further action. In certain embodiments, the ear worn device, particularly the first module, comprises a contact sensor, configured to pick up sounds from inside the body of the user when the user wears the ear worn device, particularly when the first module is inserted at least partially into the ear canal of the user. In particular, the contact sensor comprises a contact microphone. In particular, the contact sensor is configured to be placed against an inside surface of the ear canal of the user when the user is wearing the ear worn device. In particular, the contact sensor is configured to contact the skin on the inner surface of the ear canal, wherein the contact sensor is oriented perpendicular to the ear canal. In particular, the sound signals picked up by the contact sensor can be used as biometric data or for sound processing.

In certain embodiments, the ear worn device comprises a housing covering at least the first module, wherein the housing is configured to seal the ear canal of the user.

In certain embodiments, the first module comprises an electronic part comprising at least the loudspeaker and the at least one microphone, particularly the first ambient microphone and the in-ear microphone of the first module.

In certain embodiments, the first module comprises a first ambient microphone that picks up sounds from the wearer's environment. In particular, this microphone sits close to the entrance to the ear canal, behind the tragus, and faces away from the ear canal (in particular, the first ambient microphone is a MEMS digital microphone).

In certain embodiments, the first module comprises a loudspeaker facing into the user's ear canal to playback sounds to the user (in particular, the loudspeaker is a MEMS loudspeaker, a balanced armature or an electrodynamic loudspeaker).

In certain embodiments, the first module comprises an in-ear microphone facing into the user's ear canal to pick up sound inside the ear canal (in particular, the in-ear microphone is a MEMS digital microphone).

In certain embodiments, the first module comprises a sensor or sensors to pick up biometric signals from the wearer, e.g. heart rate, SpO2, core body temperature, respiration rate (this sensor may also be used to detect whether the user is wearing the device).

In certain embodiments, the first module comprises connection points (e.g. solder pads or a connector component) that allow electric connection of the transducer bundle (first module) to the main electronics bundle (second module).

In certain embodiments, the first module comprises a flexible substrate onto which the transducers and wire connection points are affixed.

In certain embodiments, the first module comprises materials and a structure (e.g. a housing) that houses all of the above, fits comfortably and securely into the wearer's ear and provides the necessary passive attenuation of noise to enable the overall purpose of the device, e.g. if noise cancelling is required, the overall transducer bundle should create a seal in the ear canal to prevent sounds leaking through.

In certain embodiments, the first module comprises an electronic component, e.g., a silicon component comprising the loudspeaker, the first ambient microphone, the in-ear microphone and/or the biometric sensor.

In certain embodiments, the second module comprises at least one second ambient microphone forming a microphone array with the first ambient microphone of the first module to achieve directional listening. In particular, the first ambient microphone and the second ambient microphone are spaced apart by at least 1 cm, more particularly in a horizontal direction. In particular, the second ambient microphone may also be used to pick up the user's own voice, e.g. for voice calls or for talking to an automatic voice assistant.

In certain embodiments, the second module comprises a power source, particularly a rechargeable battery, which is electrically connected to the loudspeaker and/or the first ambient microphone and/or the in-ear microphone to provide electrical energy to the loudspeaker, the first ambient microphone and/or the in-ear microphone.

In certain embodiments, the second module comprises a control device, particularly a microprocessor chip, configured to control components of the first module and/or the second module, wherein particularly the control device is comprised in the at least one electronic component.

In certain embodiments, the second module comprises an amplifier configured to drive the loudspeaker of the first module, wherein particularly the amplifier is comprised in the at least one electronic component.

In certain embodiments, the second module comprises a movement and/or acceleration sensor, particularly an inertial measurement unit, wherein particularly the movement and/or acceleration sensor is comprised in the at least one electronic component.

In certain embodiments, the second module comprises an altimeter, an ambient temperature sensor, an air quality sensor and/or a humidity sensor.

In certain embodiments, the second module comprises a memory device configured to store data, wherein particularly the memory device is comprised in the at least one electronic component. This memory may be used, e.g., to store data generated from the at least one biometric sensor, or store data generated during sound processing of the picked-up sounds.

In certain embodiments, the second module comprises a user interface, particularly comprising a button, e.g., a mechanical switch, a touch sensor, e.g., a capacitive sensor, a force sensor and/or a light emitting diode. Such a user interface can be used to receive input from the user, particularly to change operation of the electro acoustic system of the ear worn device, e.g. to accept or reject an incoming call, switch an active noise control function on or off or change the volume of audio playback.

In certain embodiments, the second module comprises a communication device, particularly comprising a radio antenna, more particularly a radio antenna configured to receive and/or transmit signals at a frequency between 2,402 GHz and 2,480 GHz, wherein particularly the communication device is comprised in the at least one electronic component.

In particular, the communication device may be used to receive data from a mobile device, e.g. a smart phone, of the wearer, e.g. to play back an audio file. In addition, the communication device may be used to transmit data, e.g. biometric data picked up by the at least one biometric sensor, to the mobile device of the wearer.

In certain embodiments, the second module comprises a signal processing device configured to process signals obtained from the first ambient microphone, the second ambient microphone and/or the in-ear microphone, wherein particularly the ear worn device is configured to play back the processed signals to the loudspeaker of the first module, wherein particularly the signal processing device is comprised in the at least one electronic component.

Using the signal processing device, signal processing algorithms may be performed on the picked-up sound signal from the at least one microphone, and the processed sound signal may be played back via the loudspeaker, e.g. to perform noise cancelling, or selectively play back certain environmental sounds.

In certain embodiments, the at least one electronic component is operatively coupled to the loudspeaker and/or the at least one microphone of the first module by an electric connection, particularly a wire connection or a connection via the electric contacts of a printed circuit board, more particularly a flexible printed circuit board, or a data connection, particularly a wireless data connection.

In certain embodiments, the second module comprises a rechargeable battery, e.g. lithium ion coin cell.

In certain embodiments, the second module comprises a main printed circuit board, PCB, which may comprise rigid and flexible parts.

In certain embodiments, the PCB accommodates or comprises a microprocessor chip and particularly associated passives.

In certain embodiments, the PCB accommodates or comprises a radio chip and particularly associated passives (in particular, the radio chip is a Bluetooth chip).

In certain embodiments, the PCB accommodates or comprises power management electronics, e.g. for voltage regulation and battery charge management.

In certain embodiments, the microprocessor chip (particularly with associated passives), the radio chip (particularly with associated passives) and/or the power management electronics are contained on a single System-on-Chip (SoC).

In certain embodiments, the PCB accommodates or comprises a speaker amplifier capable of driving the loudspeaker in the transducer bundle (first module).

In certain embodiments, the PCB accommodates or comprises a sensor or sensors relevant to the purpose of the device, e.g. an inertial measurement unit, IMU.

In certain embodiments, the PCB accommodates or comprises a memory, e.g. a flash memory for storage and retrieval of data.

In certain embodiments, the PCB accommodates or comprises at least one second ambient microphone to form a microphone array along with the transducer bundle ambient microphone (first ambient microphone) in order to achieve directional listening features (the second ambient microphone(s) is/are particularly (a) MEMS digital microphone(s).

In certain embodiments, the PCB accommodates or comprises an LED to form part of the user interface to the device.

In certain embodiments, the PCB accommodates or comprises an input sensor or sensors, e.g. button, touch sensor, force sensor, to form part of the user interface to the device.

In certain embodiments, the PCB accommodates or comprises an antenna for the radio (in particular 2.4 GHz for a Bluetooth radio), particularly in the form of a piece of bent metal, a PCB or a printed antenna affixed to the case/housing of the device.

In certain embodiments, the PCB accommodates or comprises metal contacts for connection to a battery charge or data transfer circuit.

In certain embodiments, the second module comprises a haptic transducer, e.g., to create a vibration in response to a user input, e.g., a manual user button action.

Wherever alternatives for single separable features are laid out herein as “embodiment”, it is to be understood that such alternatives may be combined freely to form discrete embodiments of the invention disclosed herein.

Exemplary embodiments of the invention are described with reference to the Figures, wherein

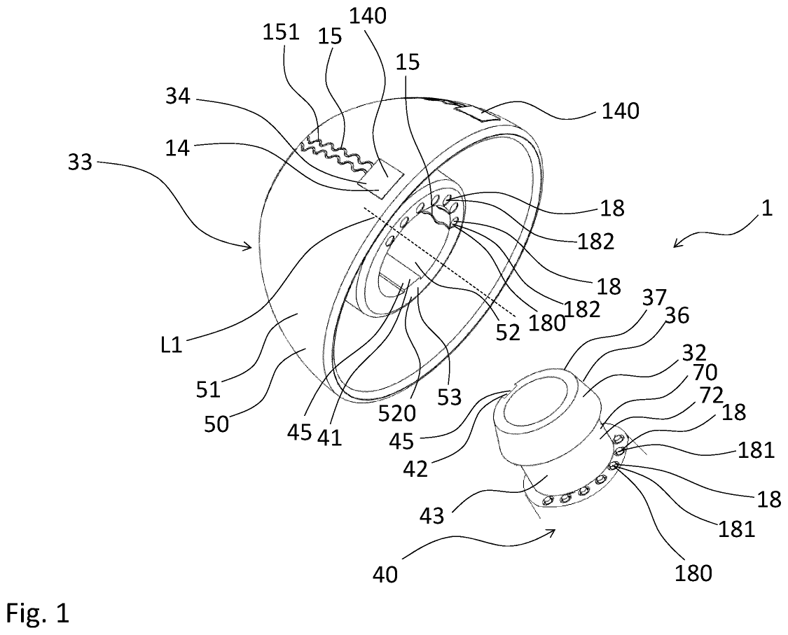

FIG. 1 shows a perspective view of a section of an embodiment of the base unit and an embodiment of an ear tip according to the invention,

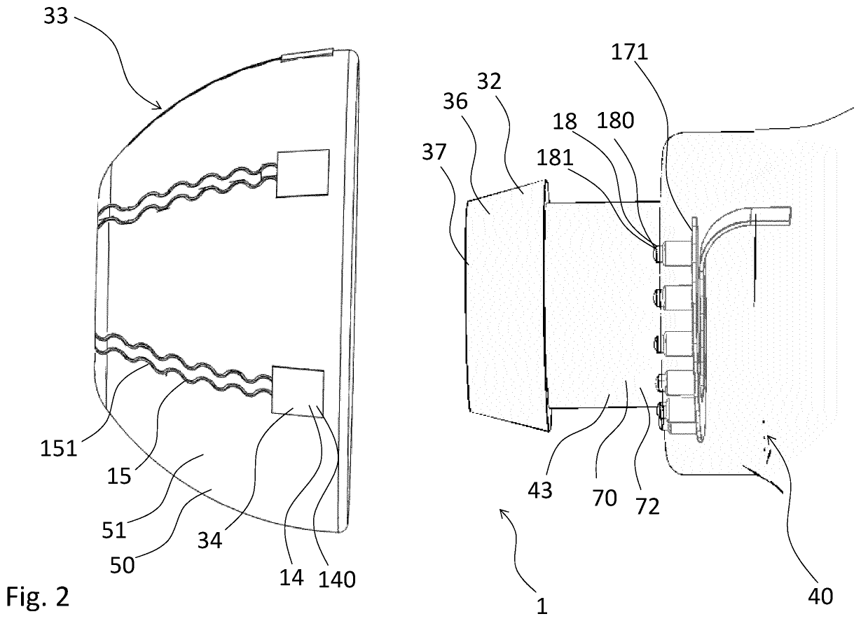

FIG. 2 shows a side view of a section of an embodiment of the base unit and an embodiment of an ear tip according to the invention

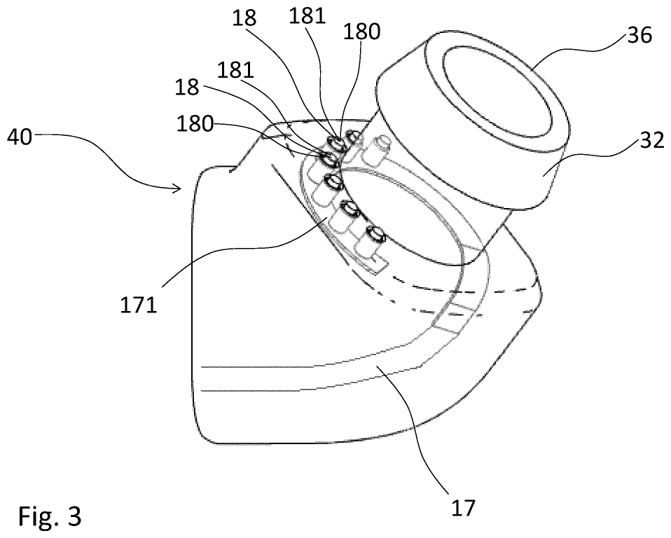

FIG. 3 shows an embodiment of a base unit,

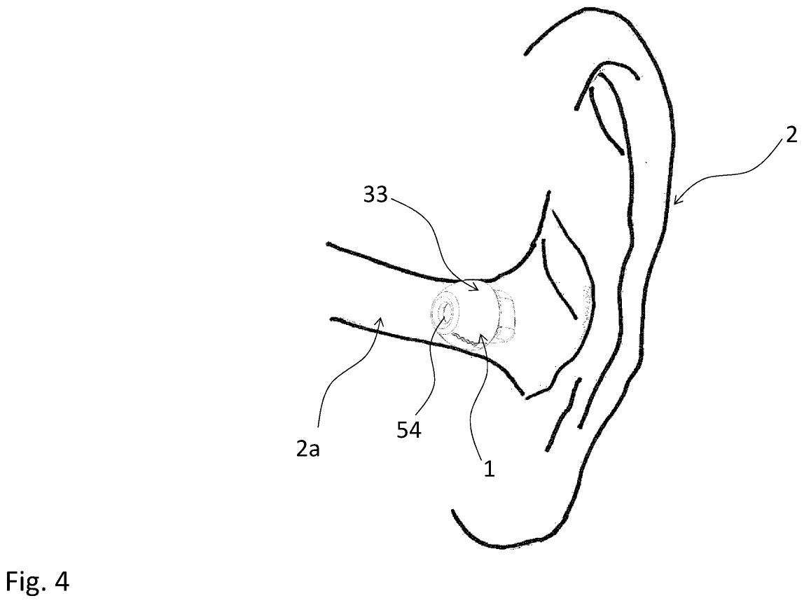

FIG. 4 illustrates a portion of an ear-worn device arranged in the ear canal of a user,

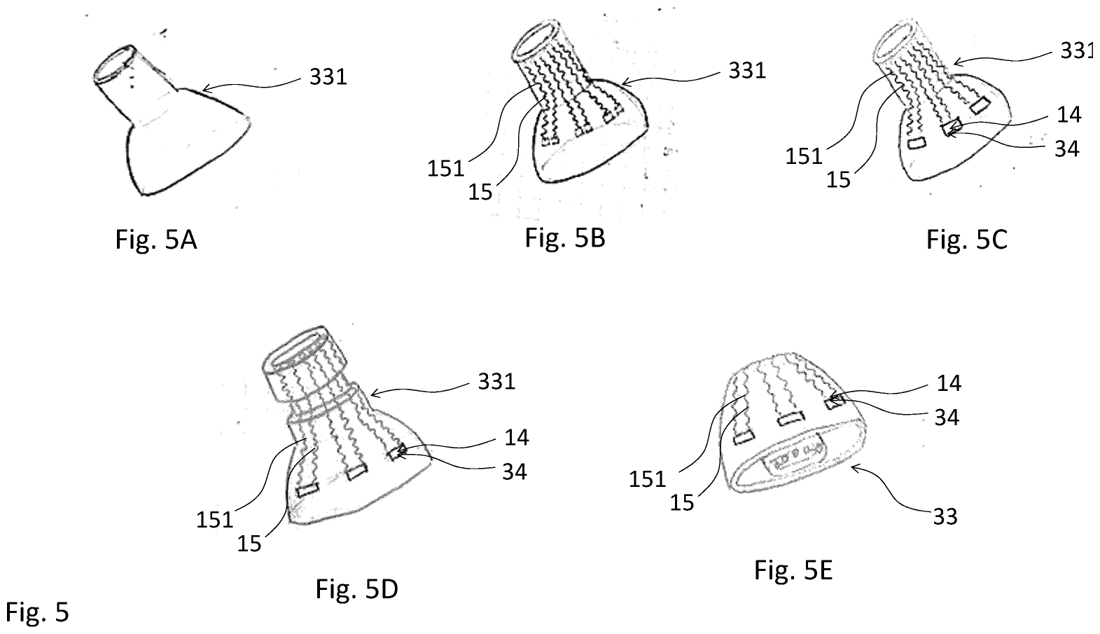

FIG. 5 illustrates a method to produce an ear pad according to the invention,

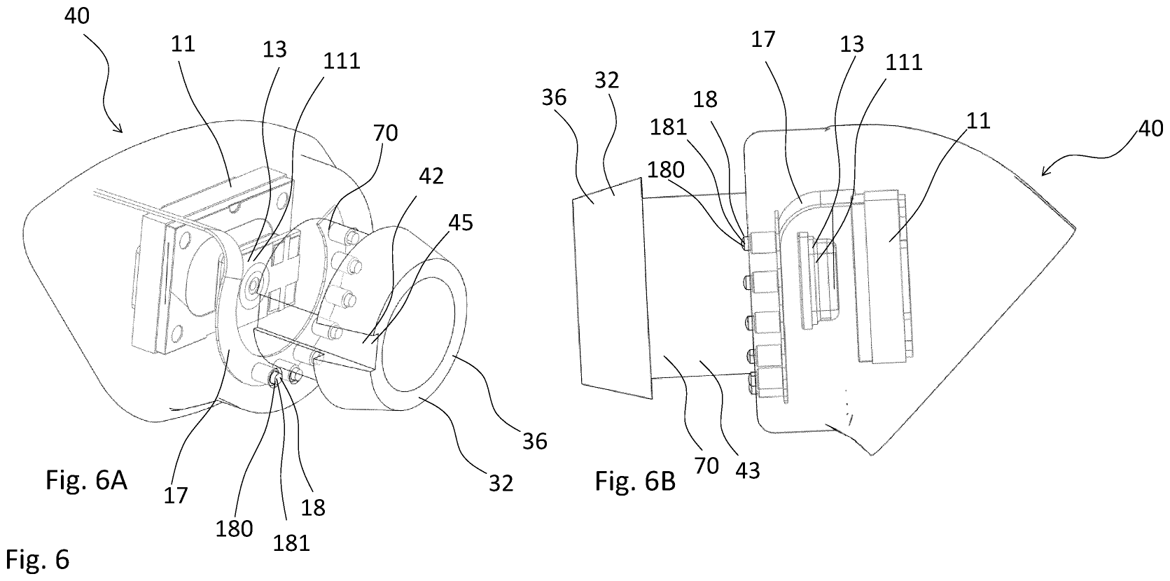

FIG. 6 shows an embodiment of a base unit, and

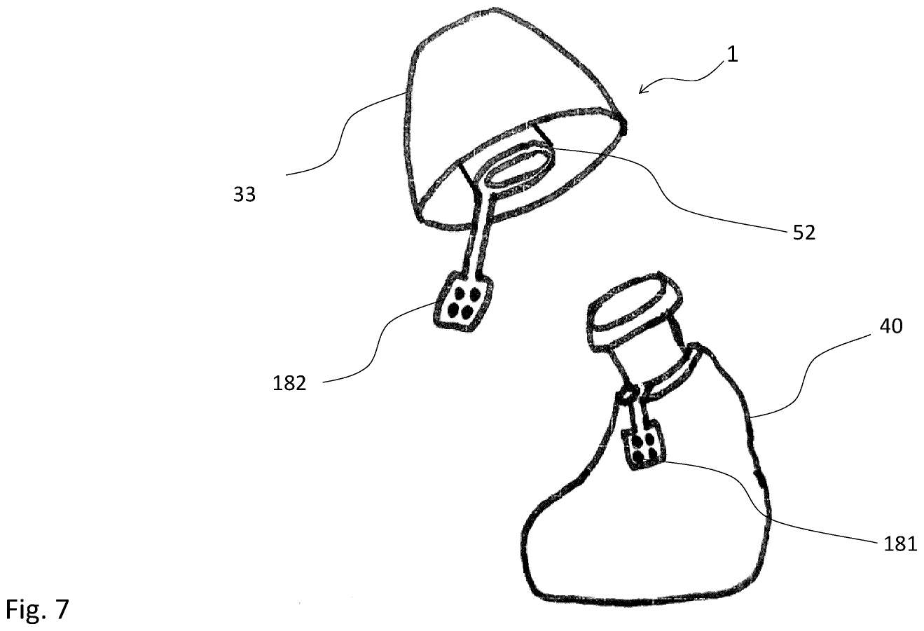

FIG. 7 shows a further embodiment of an ear worn device in a disassembled state.

FIG. 1 and FIG. 2 show different views of embodiments of the ear tip 33 according to the invention and a part of the base unit 40 according to the invention. The embodiment of the base unit 40 and the embodiment of the ear tip 33 are shown in a disassembled state. FIGS. 1 and 2 show a portion of an embodiment of an ear-worn device 1 in a disassembled state. FIGS. 1 and 2 show an embodiment of the ear tip 33 detached from a base unit 40 according to the invention (portion of an embodiment of a base unit 40 illustrated). In FIG. 3 and FIG. 6, embodiments of a part of the base unit 40 are illustrated. FIG. 4 illustrates an embodiment of a portion of the ear-worn 1 device arranged in an ear 2 of a user. The embodiment of the base unit 40 and the embodiment of the ear tip 33 are shown in an assembled state.

The ear tip 33 can have a mushroom shape. The ear tip can comprise a channel portion 52 and an outer part 50. The channel portion 52 can be considered as a mushroom stem. The outer part 50 can be considered as mushroom head. The outer part 50 can comprise a surface 51. The outer part 50 can have a dome shape. The outer part 50 can have a convex shape (FIG. 1, FIG. 2). The outer part 50 can be centred around the distal opening 54 of the channel portion 52 (FIG. 4). The channel portion 52 can extend along a first longitudinal axis L1 (FIG. 1). The outer part 50 can extend radially symmetrical with respect to the first longitudinal axis L1. The channel portion 52 can form a through-opening from the distal opening 54 to the proximal end 53. The channel portion 52 can form a through-opening along the first longitudinal axis L1.

The ear tip 33 can comprise a sensor 14, particularly a skin-contact sensor 34. The ear tip 33 can comprise a sensor assembly 140. The sensor assembly 140 can comprise at least one sensor 14.

The ear tip 33 can comprise a connection contact 18. The ear tip 33 can comprise a first electrical connector element 182. The first electrical connector element 182 can be arranged at a proximal end 53 of the channel portion 52 (FIG. 1). The first electrical connector element 182 can be arranged such that it faces away from the distal opening 54 of the channel portion 52. The first electrical connector element 182 can be a metal pad 182. In the context of the application, the first electrical connector element 182 is also referred to as connection contact 18.

The ear tip 33 can comprise an electrical connection 15, particular a flexible conductor 151, operatively connecting the sensor 14 and the first electrical connector element 182. The flexible conductor 151 can electrically conductively connect the sensor assembly 140 and the first electrical connector element 182. In the context of the application, the second electrical connector element 181 is also referred to as connection contact 18. The first electrical connector element 182 and the second electrical connector element 181 can form an electrical connector assembly 180. The electrical connector assembly 180 can comprise the connection contact 18.

The flexible conductor 151 can be embedded in the ear tip 33. The flexible conductor 151 can extend along a conductor extension direction from the sensor 14 via the outer part 50 centred around the distal opening 54 towards the first electrical connector element 182 arranged at a proximal end 53 of the channel portion 52. The flexible conductor 151 can be curved substantially perpendicular to the conductor extension direction. This can prevent the flexible conductor 151 from breaking when the ear tip 33 is compressed.

The ear-worn device 1 can comprise an alignment key 45. The alignment key 45 can comprise a first mechanical alignment element 41 and a second mechanical alignment element 42. The ear tip 33 can comprise the first mechanical alignment element 41. The first alignment element can be a protrusion 41 (FIG. 1).

The base unit 40 can comprise a core part 32 (or core portion 32). The core part 32 can comprise an engaging element 36 (FIGS. 1, 2, 3 6). The engaging element 36 can be a circumferential flange (FIG. 2). The core portion 32 can comprise a recess 43.

The base unit can comprise a connection contact 18. The base unit 40 can comprise a second electrical connector element 181. The second electrical connector element 181 can be a pogo pin 181. The second electrical connector element 181 can be arranged such that it faces away from a main body of the base unit 40.

The protruding core portion 32 of the base unit 40 can particularly be shaped such that it is (at least partially) insertable in the channel portion 52 of the ear tip 33. The ear-worn device can comprise a locking mechanism to achieve a snapping connection between the core portion 32 and the sleeve part 33, when the core portion 32 is inserted into the sleeve part 33.

The ear-worn device 1 can comprise a mechanical connector assembly 70. The mechanical connector assembly 70 can comprise a first mechanical connector element 71 and a second mechanical connector element 72.

The mechanical connector assembly 70 can establish a locking mechanism. It can comprise a recess 43. The recess 43 be comprised in the core portion 32. A corresponding counter part (corresponding recession) can be comprised in the sleeve part 33 (not shown). The corresponding recession on sleeve part can be with slightly smaller dimensions for tight fit. It can create an acoustic seal.

For alignment of the core portion 32 and the sleeve part 33 (when assembling), the core part 32 and the sleeve part 33 can comprise an alignment key 45. The alignment key 45 can comprise a groove 42 and a corresponding protrusion 41. In the presented embodiment, the core part 32 comprises the groove 42 and the sleeve part 33 comprises the corresponding protrusion 41 (FIG. 1, FIG. 6).

The base unit 40, particularly the core portion 32 can comprise a rigid housing. The ear tip 33 can particularly be formed at least partially from a softer, flexible material, e.g. silicone, which shape can adapt to the shape of the ear canal of the user to achieve a tight fit in the ear canal.

The ear tip 33 can comprise one or several skin contact sensors 34, which may function as biometric sensors 14, e.g. as a PPG sensor that can be used to determine the heart rate from measuring blood flow under the skin. In particular, the skin contact sensors 34 are arranged on the surface 51 of the outer part 50 of the sleeve part 33, such that they can be in contact with the skin on the inner surface of the ear canal to detect a signal when the user is wearing the ear-worn device 1.

The sensors 14, particularly the sensor assemblies 140, can be connected to electrical connection contacts 18 on the proximal end 53 of the channel portion 52 by electrical connections 15. The electrical connection 15 can be a stretchable conductor 151.

The base unit 33 can comprise corresponding electrical connection contacts 18 on its outer surface, e.g. in form of circumferentially extending rings of a conductive material on the outside surface of the base unit 33 (see FIGS. 1, 2, 3, 6). A connecting contact 18 arranged at the base unit 33 can be a pogo pin connector 181. A connecting contact 18 arranged at the sleeve part 33 can be a corresponding pad 182.

The contact pad 182 can be configured for pogo pin 181 mating. The pogo pin 181 can be configured for mating with contacts on sleeve part 33, connecting sensors 14, 34 (or a sensor assembly 140) back to the base unit 40. The base unit 40 can comprise a processing unit. The pogo pin 181 can be configured for mating with contacts on sleeve part 33, connecting sensors 14, 34 (or a sensor assembly 140) back to the processing unit of the base unit 40.

When the core part 32 is inserted into the channel portion 52 of the ear tip 33, the connection contacts 18, 181, 182 of the core part 32 and the sleeve part 33 are aligned to establish an electrical connection between the sensor 14 and electronical components of the base unit 40.

The base unit 40 can comprise a PCB 17. In an embodiment, the connection contact 18, particularly the pogo pin 181 is arranged at the PCB, in particular at a rigid section 171 of the PCB (FIG. 3). The base unit 40 can comprises a plurality of pogo pin connector 181 arranged at the rigid section 171 of the PCB. The PCB can comprise the rigid section 171 and the flexible section 17. The PCB flexible section 17 can connect to the processing unit of the base unit 40.

The base unit 40 can comprise a microphone 111. The microphone can be an in-ear microphone 13. The base unit 40 can comprise a loudspeaker 11, particularly a MEMS loudspeaker 11 (FIG. 6).

In an embodiment, the base unit 40 and the corresponding sleeve part 33 are configured such that an ear-worn device 1 with embedded electronics is achieved wherein via the connector mechanism and the combination of technologies the sleeve part can be easily removed from the base unit by the user (and might be replaced).

In FIG. 4, a positioning of an ear tip 33 attached to a base unit in the ear 2 of a user is illustrated, particularly that the ear tip 33 can be inserted partly in the ear canal 2a. The sensor assembly 14, 34 can be in contact with the skin in the ear canal 2a.

FIG. 5 illustrates an embodiment of production steps of the ear tip 33, i.e. the steps of the method to produce a sleeve part 33. In particular, the sleeve part 33 is made of a soft material, particularly a soft, bio-compatible material. It can be manufactured by moulding (FIG. 5A).

In a further step, the production steps can comprise a step of transferring the circuit to a soft part 331, i.e. a pre-state 331 of the ear pad 33 (FIG. 5B). In an embodiment, the conductors 15, 151 are stretchable. The circuit can be transferred to the soft part 331 as that described in DE 102018205265B3. This can include a pressing step. It can include an irradiation process. The conductors 15, 151 can be curvy. Advantageously, a curved conductor 15, 151 has a reduced risk of breakage if it is stretched and/or compressed.

The soft part 331 can be flattened out so that the conductors 15, 151 can be transferred using a 2D inkjet printing process. In an embodiment of the method, a 3D printing process is used to transfer the conductors 15, 151 with the soft part 331 in its normal 3D shape. This can be achieved via using a aerosol jet 3D printing. In an embodiment, the soft part 331 is dipped into a tank to transfer the circuit 15 as for instance described in DE 102018205265B3.

A step of the method can comprise the assembling of the sensor assembly 14, 34, particularly the biometric sensing components (biological sensor, biometric sensor) 14, 34 onto the circuit: The biometric sensing components 14, 34 can be soldered to the pads on the circuit. This may be done by hand. This can be done by a pick-and-place machine, in particular if the soft part 331 is flattened. The conductors 15, 151 and biometric sensing components 14, 34 can be covered by a protective layer as the completed sleeve part will be exposed to moisture inside the ear of the user. The protective layer can be clear in any areas where line-of-sight is required, e.g. for light transfer to and from the skin by biometric sensors (FIG. 5C). In an embodiment, the conductor 15, 151 and/or the sensor assembly 14, 34 is embedded in the ear pad 33.

A further step of the method can comprise a forming of the pre-state 331 of the ear pad 33 into its final shape. A step of the method can comprise a forming of the sleeve part 33 from the pre-state 331 of the sleeve part, i.e. from the soft part 331: It may be necessary to form the soft part into a 3D shape that puts the first electrical connector element, for instance a conductive pad, in the right orientation for contact with the second electrical connector element, for instance the a pogo pin connector. This may be achieved by thermoforming the soft part. It may also be necessary to add an extra part, such as an extra part related to the mechanical connector assembly and/or the alignment assembly. The mechanical connector assembly can comprise a locking mechanism (FIG. 5D, FIG. 5E).

In an embodiment, the assembling of the biometric sensors 14, 34 onto the circuit is performed prior to forming of the ear pad from its pre-state (soft part). In an embodiment, the formation of the ear pad from the soft part is performed prior to the assembling of the biological sensor onto the circuit.

A further embodiment of an ear worn device 1 in the disassembled state is shown in FIG. 7. The first electrical connector element 182 can protrude from the channel portion 52.

1. An ear-worn device (1), particularly an earphone or a hearing aid, comprising:
a base unit (40), and
an ear tip (33), wherein the ear tip (33) comprises a sensor (14, 34) configured to detect a biological signal and to issue an electrical sensor signal indicative of the detected biological signal, wherein the base unit (40) and the ear tip (33) are repeatedly and removably connectable via a mechanical connector assembly (70) of the ear-worn device (1), wherein the ear-worn device (1) comprises an electrical connector assembly (180), particularly comprising an electrically conductive mating connection, wherein the electrical connector assembly (180) is configured to conduct the sensor signal from the sensor (14, 34) to the base unit (40), characterised in that the electrical connector assembly (180) comprises a first electrical connector element (182) of the electrical connector assembly (180) arranged at the ear tip (33) and a second electrical connector element (181) of the electrical connector assembly (180) arranged at the base unit (40), wherein the first electrical connector element (182) of the electrical connector assembly (180) is operatively coupled to a sensor assembly (140) comprising the sensor (14, 34), wherein the first electrical connector element (182) of the electrical connector assembly (180) is configured and arranged to contact the second electrical connector element (181) of the electrical connector assembly (180) that is formed complementary to the first electrical connector element (182), and/or in that the mechanical connector assembly (70) comprises a first mechanical connector element (71) of the mechanical connector assembly (70) arranged at the ear tip (33) and a corresponding second mechanical connector element (72) of the mechanical connector assembly (70) arranged at the base unit (40), wherein the mechanical connector assembly (70) is arranged and configured such that in an assembled state, the ear tip (33) and the base unit (40) are friction locked and/or positively coupled, such that an electrical connection via the electrical connector assembly (180) is established.

2. The ear-worn device (1) according to claim 1, characterised in that, the mechanical connector assembly (70) comprises or consists of:
a clip and a corresponding recess,
a groove and a corresponding protrusion, and/or
a magnet and a magnetic counterpart.

3. The ear-worn device (1) according to claim 1, characterised in that the base unit (40) comprises a protruding core portion (32) and the ear tip (33) comprises a central part that comprises a hollow channel portion (52) formed complementary to the protruding core portion (32), wherein the core portion (32) and the channel portion (52) are configured such that the core portion (32) is at least partially insertable in the channel portion (52), wherein at a distal end (37) of the protruding core portion (32) the core portion (32) comprises an engaging element (36), that is configured to engage with a proximal end (53) of the channel portion (52), when the core portion (32) is inserted in the central part, particularly in the channel portion (52), such that at least a positive lock between the base unit (40) and the ear tip (33) is established.

4. The ear-worn device (1) according to claim 1, characterised in that the ear tip (33) is formed in a mushroom shape, wherein the ear tip (33) comprises:
a central part (520), wherein the central part comprises a channel portion (52), particularly a hollow channel portion (52), extending along a longitudinal extension direction (L1), wherein the channel portion (52) comprises a distal end and a proximal end (53), wherein at the distal end, the channel portion (52) delimits a distal opening (54),
an outer part (50) emerging radially with respect to the longitudinal extension direction (L1) of the channel portion (52) from or connected to the distal end of the channel portion (52), extending towards the proximal end (53) of the channel portion (52), wherein the outer part (50) comprises a surface (51), wherein the surface (51) is configured to be in contact with an internal surface of an ear canal (2a) when the ear tip (33) is inserted into the ear canal (2a) of a user,
a sensor assembly (140) comprising the sensor (14, 34), particularly a skin-contact sensor (34), wherein the sensor (14, 34) is arranged at the outer part (50), particularly at the surface (51) of the outer part (50), and
the first electrical connector element (182) of the electrical connector assembly (180) operatively coupled to the sensor assembly (140).

5. The ear-worn device (1) according to claim 1, characterised in that the sensor (14, 34) and/or the sensor assembly (140) is operatively coupled to the first electrical connector element (182) of the electrical connector assembly (180) by a flexible electrical connection (15, 151), particularly wherein the flexible electrical connection (15, 151) comprises or consists of a flexible conductor (151) and/or a flexible printed circuit board embedded in the ear tip (33) and/or wherein the ear tip (33) or a section of the ear tip (33) consists of a conductive material, and/or in that the ear tip (33) comprises a first mechanical alignment element (41) that is particularly comprised in the first mechanical connector element (71) and the base unit (40) comprises a corresponding second mechanical alignment element (42), particularly comprised in the second mechanical connector element (72), wherein the two alignment elements (41, 42) are configured and shaped such that the base unit (40) and the ear tip (33) may only be assembled with a orientation to each other that is defined by the shape of the two alignment elements (41, 42) such that the first electrical connector element (182) and the second electrical connector element (181) are directly facing each other and/or such that the base unit (40) and the ear tip (33) are aligned with each other such that the base unit (40) and the ear tip (33) are mechanically connectable via the mechanical connector assembly (70).

6. The ear-worn device (1) according to claim 1, characterised in that the electrical connector assembly (180) comprises a spring-loaded electrical contact pin (181) and a metal pad (182), particularly wherein the first electrical connector element (182) is the metal pad (182) and the second electrical connector element (181) is the spring-loaded electrical contact pin (181), and/or in that the electrical connector assembly (180) comprises a male pin and a corresponding female receptable configured to receive the male pin to generate the electrical connection, wherein the male pin and/or the female receptable are configured such that they press together in the assembled state.

7. The ear-worn device (1) according to claim 1, characterised in that the base unit (40) comprises a loudspeaker (11) and/or a microphone (13, 111), and/or in that the base unit (40) comprises a loudspeaker (11), wherein the loudspeaker (11) is arranged such that it faces towards the core portion (32), particularly a distal end (37) of the protruding core portion (32), wherein when the ear tip (33) is connected to the base unit (40), the loudspeaker (11) can emit a sound through the channel portion (52) of the ear tip (33), particularly such that the loudspeaker (11) can emit a sound through the distal opening (54) of the ear tip (33), and/or in that the base unit (40) comprises a processing unit configured to receive, process, store and/or send a sensor signal obtained by the sensor (14, 34), particularly the sensor assembly (140), and/or processed data, particularly wherein the ear-worn device (1) comprises the microphone (13, 111) and the loudspeaker (11), wherein the microphone (13, 111) is arranged distal to the loudspeaker (11), such that when the ear worn device (1) is arranged in the ear canal (2a) of a user the microphone (13, 111), the loudspeaker (11) and the ear canal (2a) form an acoustic chamber, wherein the loudspeaker (11) is arranged and configured to output an audio signal into the acoustic chamber and the microphone (13, 111) is arranged and configured to detect a resulting audio signal carrying information on an audio signal present in the ear (2).

8. The ear-worn device (1) according to claim 1, characterised in that the biological signal detectable by the sensor (14, 34) and/or the sensor assembly (140) is a heart rate, a blood oxygen saturation, a body temperature, a respiration rate, blood glucose level, a hormone level, an electroencephalogram signal of the user, or a sound signal detected from inside the body of the user, and/or in that the sensor (14, 34) is a thermometer, wherein the thermometer is an infra-red thermometer, wherein the infra-red thermometer is arranged in the protruding core portion (52), wherein the infra-red thermometer is arranged and configured to detect an ear drum of the user when the ear-worn device (1) is arranged in the ear channel (2a) of the user to detect a core body temperature of the user and/or wherein the thermometer is a contact thermometer.

9. An ear tip (33), particularly the ear tip (33) according to claim 1, wherein the ear tip (33) is formed in a mushroom shape, wherein the ear tip (33) comprises:
a central part (520), wherein the central part (520) comprises a channel portion (52), particularly a hollow channel portion (52), extending along a longitudinal extension direction (L1), wherein the channel portion (52) comprises a distal end and a proximal end (53), wherein at the distal end, the channel portion (52) limits a distal opening (54),
an outer part (50) emerging radially with respect to the longitudinal extension direction (L1) of the channel portion (52) from or connected to the distal end of the channel portion (52), extending towards the proximal end (53) of the channel portion (52), wherein the outer part (50) comprises a surface (51), wherein the surface (51) is configured to be in contact with an internal surface of an ear canal (2a) when the ear tip (33) is inserted into the ear canal (2a) of a user,
a sensor assembly (140) comprising the sensor (14, 34), particularly a skin-contact sensor (34), wherein the sensor (14, 34) is arranged at the outer part (50), particularly at the surface (51) of the outer part (50), and
a first electrical connector element (182) of the electrical connector assembly (180) operatively coupled to the sensor assembly (140), wherein the first electrical connector element (182) of the electrical connector assembly (180) is arranged at the proximal end (53) of the channel portion (52), wherein the first electrical connector element (182) is configured and arranged to contact a second electrical connector element (181) of the electrical connector assembly (180) arranged at a base unit (40), wherein the second electrical connector element (181) is shaped complementary to the first electrical connector element (182), wherein the first electrical connector element (182) and the second electrical connector element (181) are configured to form an electrical connector assembly (180) generating an electrically conductive connection.

10. The ear tip (33) according to claim 9, characterised in that the ear tip (33) comprises a first mechanical connector element (71) of a mechanical connector assembly (70), wherein the first mechanical connector element (71) as arranged and configured to contact a second mechanical connector element (72) of the mechanical connector assembly (70) arranged at the base unit (40), wherein the first mechanical connector element (71) and the second mechanical connector element (72) are configured to form the mechanical connector assembly (70), wherein the mechanical connector assembly (70) is arranged and configured such that in an assembled state, the ear tip (33) and the base unit (40) are friction locked and/or positively coupled, such that an electrical connection via the electrical connector assembly (180) is established.

11. The ear tip (33) according to claim 9, characterised in that the ear tip (33) comprises a first mechanical alignment element (41) that is particularly comprised in the first mechanical connector element (71), wherein the first mechanical alignment element (41) is arranged and configured to align with a second mechanical alignment element (42) arranged at the base unit (40), wherein the two alignment elements (41, 42) are configured and shaped such that the base unit (40) and the ear tip (33) may only be assembled with a orientation to each other that is defined by the shape of the two alignment elements (41, 42) such that the first electrical connector element (182) and the second electrical connector element (181) are directly facing each other and/or such that the base unit (40) and the ear tip (33) are aligned with each other such that they are mechanically connectable via the mechanical connector assembly (70).

12. A base unit (40), particularly the base unit (40) according to claim 1, wherein the base unit (40) comprises a second electrical connector element (181) of the electrical connector assembly (180), wherein the second electrical connector element (181) is configured and arranged to contact a first electrical connector element (182) of the electrical connector assembly (180) arranged at an ear tip (33), wherein the second electrical connector element (181) is shaped complementary to the first electrical connector element (182), wherein the first electrical connector element (182) and the second electrical connector element (181) are configured to form an electrical connector assembly (180) generating an electrically conductive connection.

13. The base unit (40) according to claim 12, characterised in that the base unit (40) comprises a second mechanical connector element (72) of a mechanical connector assembly (70), wherein the second mechanical connector element (72) is arranged and configured to contact a first mechanical connector element (71) of the mechanical connector assembly (70) arranged at the ear tip (33), wherein the first mechanical connector element (71) and the second mechanical connector element (72) are configured to form the mechanical connector assembly (70), wherein the mechanical connector assembly (70) is arranged and configured such that in an assembled state, the ear tip (33) and the base unit (40) are friction locked and/or positively coupled, such that an electrical connection via the electrical connector assembly (180) is established, and/or in that the base unit (40) comprises a second mechanical alignment element (42) that is particularly comprised in the second mechanical connector element (72), wherein the second mechanical alignment element (42) is arranged and configured to align with a first mechanical alignment element (41) arranged at the ear tip (33), wherein the two alignment elements (41, 42) are configured and shaped such that the base unit (40) and the ear tip (33) may only be assembled with a orientation to each other that is defined by the shape of the two alignment elements (41, 42) such that the first electrical connector element (182) and the second electrical connector element (181) are directly facing each other and/or such that the base unit (40) and the ear tip (33) are aligned with each other such that they are mechanically connectable via the mechanical connector assembly (70).

14. A method to generate an ear tip (33), particularly the ear tip (33) according to claim 1, comprising the steps of:
generating a pre-state (331) of the ear tip (33), particularly by moulding or 3D printing,
transferring a flexible electrical connection (15, 151) to the pre-state (331) of the ear tip (33), wherein transferring comprises a 2D inkjet printing process, a 3D printing process and/or a pressure and irradiation process,
assembling of a sensor (14, 34), particularly a sensor assembly (140) onto the flexible electrical connection (15, 151),
coating the flexible electrical connection (15, 151) and/or the sensor (14, 34), particularly the sensor assembly (140) by a protective layer,
forming the ear tip (33) from the pre-state (331) of the ear tip (33), particularly by thermoforming.
